(19) United States
(12) Patent Application Publication
(10) Pub. No.: US 2009/0269568 A1
(43) Pub. Date: Oct. 29, 2009

(54) DEFORMABLE FILM WITH RADIATION-CURING COATING AND SHAPED ARTICLES PRODUCED THEREFROM

(75) Inventors: Timo Kuhlmann, Krefeld (DE); Klaus Meyer, Dormagen (DE); Stefan Sommer, Leverkusen (DE); Erhard Luehmann, Bomlitz (DE); Jan Weikard, Odenthal-Erberich (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/430,359

(22) Filed: Apr. 27, 2009

(30) Foreign Application Priority Data
Apr. 28, 2008 (DE) 102008021152.4

(51) Int. Cl. B32B 5/16; B05D 3/02; B29C 39/00

(52) U.S. Cl. 428/220; 427/385.5; 428/323; 264/299

(57) ABSTRACT

The present invention relates to a film, further comprising a radiation-curing coating, wherein the coating comprises a polyurethane polymer which contains (meth)acrylate groups and which is obtainable from the reaction of a reaction mixture comprising (a) polyisocyanates and (b1) compounds which comprise (meth)acrylate groups and are reactive towards isocyanates and wherein the coating further comprises inorganic nanoparticles with an average particle size of ≧1 nm to ≦200 nm. It also relates to a process for the production of such coated films, the use of such films for the production of shaped articles, a process for the production of shaped articles with a radiation-cured coating and shaped articles which can be produced by this process.

### RELATED APPLICATIONS

This application claims benefit to German Patent Application No. 10 2008 021 152.4, filed Apr. 28, 2008, which is incorporated herein by reference in its entirety for all useful purposes.

### BACKGROUND OF THE INVENTION

The present invention relates to a film, further comprising a radiation-curing coating, wherein the coating comprises a polyurethane polymer which contains (meth)acrylate groups. It further relates to a process for the production of such coated films, the use of such films for the production of shaped articles, a process for the production of shaped articles with a radiation-cured coating and shaped articles which can be produced by this process.

Processes are known in which a polymer film is first coated over a large area by means of common lacquering processes, such as knife coating or spraying, and this coating initially dries until nearly tack-free by means of physical drying or partial curing. This film can then be deformed at elevated temperatures and subsequently bonded, back injection moulded or foamed in place. This concept offers a great deal of potential for the production of, for example, components by plastics processors, enabling the more complex lacquering step for three-dimensional components to be replaced by the simpler coating of a flat substrate.

In general, good surface properties require a high crosslink density of the coating. However, high crosslink densities lead to thermoset behaviour with maximum possible stretch ratios of only a few percent, and so the coating tends to crack during the deformation operation. This obvious conflict between the necessary high crosslink density and the desired high stretch ratio can be resolved e.g. by carrying out the drying/curing of the coating in two steps, before and after deformation. A radiation-induced crosslinking reaction in the coating is particularly suitable for post-curing.

In addition, the intermediate winding of the coated, deformable film on to rolls is necessary for an economic application of this process. The pressure and temperature stresses occurring in the rolls during this operation place particular demands on the blocking resistance of the coating.

WO 2005/080484 A1 describes a radiation-curing laminated sheet or film comprising at least one substrate layer and a top layer, which contains a radiation-curing material having a glass transition temperature below 50° C. with a high double bond density.

WO 2005/118689 A1 discloses a similar laminated sheet or film in which the radiation-curing material additionally contains acid groups. Both applications describe the top layer as not tacky; a higher blocking resistance, as needed e.g. for rolling the film around a core, is not achieved. The possibility of winding the laminated films into rolls before the radiation curing of the top layer is therefore not even mentioned.

WO 2005/099943 A2 describes a flexible laminated composite with a support and at least one layer of curable lacquer applied on to the support, in which the layer of curable lacquer comprises a double-bond-containing binder with a double bond density of between 3 mol/kg and 6 mol/kg, with a glass transition temperature Tg of between −15° C. and 20° C. and a solids content of between 40% and 100%, which is not tacky after thermal drying. The document teaches that the coating may be susceptible to contamination by dust owing to the low Tg. In the example, a degree of drying/blocking resistance of the coating before radiation curing is achieved for which, after a loading of 500 g/cm² for 60 s at 10° C., embossing marks from a filter paper are still visible. The loads on a coating in a roll of film are generally higher in terms of pressure and temperature. The possibility of winding the film on to rolls before the radiation curing of the lacquer is therefore not mentioned in this document either.

All the applications cited above also fail to mention the use of nanoscale particles as a component of the radiation-curing coating.

WO 2006/008120 A1 discloses an aqueous dispersion of nanoscale polymer particles of organic binders, wherein nanoparticles are contained in these as a highly disperse phase in addition to water and/or an aqueous colloidal solution of a metal oxide as a continuous phase and optionally also adjuvants and additives. Aqueous compositions of this type are used as a lacquer composition for coating purposes.

No details are given of the drying properties of these systems; owing to the low molecular weights, particularly of the polyurethane systems, however, only low blocking resistances can be assumed. The use of these systems for the coating of films is not mentioned.

Similarly, no indications can be found in this document of how such a dispersion behaves if it is applied on to a thermoplastic film and the film is deformed. Such coatings have to display adequate adhesion to the film substrate in particular. It is also advantageous, as already mentioned, to have the highest possible blocking resistance so that the coated but uncured film can be wound on to rolls.

In the prior art, the need therefore still exists for improved or at least alternative films with radiation-curing coatings. Films of this type in which the coating displays high abrasion resistance with, at the same time, good adhesion to the film after deforming and curing would be desirable. Independently of this, improved or at least alternative films would also be desirable in which the coating exhibits such a high blocking resistance before deforming that the film can be rolled up without any problems but high stretch ratios can nevertheless be achieved in the deformation process.

The present invention has set itself the object of at least partly overcoming the disadvantages in the prior art. In particular, it has set itself the object of providing improved or at least alternative films with radiation-curing coatings.

### EMBODIMENTS OF THE INVENTION

An embodiment of the present invention is a film comprising a radiation-curing coating, wherein said radiation-curing coating comprises a polyurethane polymer comprising (meth)acrylate groups and which is obtained from the reaction of a reaction mixture comprising:
(a) polyisocyanates; and
(b1) compounds which comprise (meth)acrylate groups and are reactive towards isocyanates
   and wherein said radiation-curing coating further comprises inorganic nanoparticles having an average particle size in the range of from 1 nm to 200 nm.

Another embodiment of the present invention is the above film, wherein said film is a polycarbonate film with a thickness in the range of from 10 μm to 1500 μm.

Another embodiment of the present invention is the above film, wherein the weight average Mw of said polyurethane polymer is in the range of from 250000 g/mol to 350000 g/mol.

Another embodiment of the present invention is the above film, wherein said reaction mixture further comprises:
(b2) hydrophilically modified compounds with ionic groups and/or groups capable of conversion to ionic groups and/or nonionic groups;
(b3) polyol compounds having an average molecular weight in the range of from 50 g/mol to 500 g/mol and a hydroxyl functionality of 2 or greater; and
(b4) aminofunctional compounds.

Another embodiment of the present invention is the above film, wherein said reaction mixture further comprises:
(b5) polyol compounds with an average molecular weight in the range of from 500 g/mol to 13000 g/mol and an average hydroxyl functionality in the range of from 1.5 to 5.

Another embodiment of the present invention is the above film, wherein the number of hydroxyl groups in (b3) represents a proportion of the total amount of hydroxyl groups and amino groups in the range of from 5 mole % to 25 mole %, and wherein the hydroxyl groups of water in the reaction mixture are not taken into account.

Another embodiment of the present invention is the above film, wherein said radiation-curing coating further comprises:
(b6) compounds which comprise (meth)acrylate groups and are non-reactive towards isocyanates and/or have not been reacted.

Another embodiment of the present invention is the above film, wherein the surface of said inorganic nanoparticles in said coating is modified by the covalent and/or non-covalent attachment of other compounds.

Yet another embodiment of the present invention is a process for producing the above film, comprising:
preparing a polymer dispersion, wherein said dispersion comprises a polyurethane polymer which comprises (meth)acrylate groups and which is obtained from the reaction of a reaction mixture comprising:
(a) polyisocyanates; and
(b1) compounds which comprise (meth)acrylate groups and are reactive towards isocyanates;
and wherein said dispersion also comprises inorganic nanoparticles having an average particle size in the range of from 1 nm to 200 nm;
coating a film with said polymer dispersion; and
drying said polymer dispersion.

Yet another embodiment of the present invention is a shaped article comprising the above film.

Yet another embodiment of the present invention is a process for producing a shaped article comprising a radiation-cured coating comprising:
preparing the above film;
forming said film into a shaped article; and
curing the radiation-curing coating on said shaped article.

Another embodiment of the present invention is the above process, wherein the forming of the shaped article takes place in a mould under a pressure in the range of from 20 bar to 150 bar.

Another embodiment of the present invention is the above process, wherein the forming of the shaped article takes place at a temperature in the range of from 20° C. to 60° C. below the softening point of the material of said film.

Another embodiment of the present invention is the above process, further comprising applying a polymer onto the side of said film opposite the cured radiation-curing coating.

Yet another embodiment of the present invention is a shaped article produced by the above process.

### DESCRIPTION OF THE INVENTION

According to the invention, therefore, a film is proposed which further comprises a radiation-curing coating, wherein the coating comprises a polyurethane polymer which contains (meth)acrylate groups and which is obtainable from the reaction of a reaction mixture comprising:
(a) polyisocyanates and
(b1) compounds which comprise (meth)acrylate groups and are reactive towards isocyanates
   and wherein the coating further comprises inorganic nanoparticles with an average particle size of ≧1 nm to ≦200 nm.

Such films may be used e.g. for the production of shaped articles which exhibit structural elements with very small radii of curvature. The coatings exhibit good abrasion resistance and chemical resistance after curing.

The film to be used according to the invention advantageously possesses, in particular, the necessary thermal deformability in addition to the general resistance that is required. Suitable in principle, therefore, are in particular thermoplastic polymers such as ABS, AMMA, ASA, CA, CAB, EP, UF, CF, MF, MPF, PF, PAN, PA, PE, HDPE, LDPE, LLDPE, PC, PET, PMMA, PP, PS, SB, PUR, PVC, RF, SAN, PBT, PPE, POM, PP-EPDM and UP (abbreviations in accordance with DIN 7728 part 1) and mixtures thereof, as well as laminated films constructed from two or more layers of these plastics. In general, the films to be used according to the invention may also contain reinforcing fibres or fabrics, provided that these do not impair the desired thermoplastic deformation.

Particularly suitable are thermoplastic polyurethanes, polymethyl methacrylate (PMMA) and modified variants of PMMA, as well as polycarbonate (PC), ASA, PET, PP, PP-EPDM and ABS.

The film or sheet is preferably used in a thickness of ≧10 μm to ≦1500 μm, more preferably from ≧50 μm to ≦1000 μm and particularly preferably from ≧200 μm to ≦400 μm. In addition, the material of the film may contain additives and/or processing auxiliaries for film production, such as e.g. stabilisers, light stabilisers, plasticisers, fillers such as fibres, and dyes. The side of the film intended for coating as well as the other side may be smooth or may exhibit a surface structure, a smooth surface being preferred for the side to be coated.

In one embodiment, the film is a polycarbonate film with a thickness of ≧10 μm to ≦1500 μm. This also includes a polycarbonate film with the aforementioned additives and/or processing auxiliaries. The thickness of the film can also be ≧50 μm to ≦1000 μm or ≧200 μm to ≦400 μm.

The film can be coated on one or both sides, single-sided coating being preferred. In the case of single-sided coating, a thermally deformable adhesive layer may optionally be applied to the reverse of the film, i.e. to the surface on which the coating composition has not been applied. Depending on the method, hot-melt adhesives or radiation-curing adhesives are suitable for this purpose. In addition, a protective film which is likewise thermally deformable may also be applied on to the surface of the adhesive layer. It is further possible to provide the reverse of the film with support materials such as fabrics, but these should be deformable to the desired extent.

Before or after applying the radiation-curing layer, the film may optionally be lacquered or printed with one or more layers. This may take place on the coated or on the uncoated side of the film. The layers may be coloured or functional, and applied over the entire surface or only part thereof, e.g. as a printed image. The lacquers used should be thermoplastic so that they do not crack during subsequent deformation. Printing inks as commercially available for so-called “in-mould decoration” processes can be used.

The radiation-curing coating of the film may later represent the surface of consumer articles. According to the invention, it is provided that this comprises a polyurethane polymer. This polyurethane polymer can also comprise additional polymer units, e.g. polyurea units, polyester units etc. The polyurethane polymer contains (meth)acrylate groups. The term (meth)acrylate groups within the meaning of the present invention is to be understood as comprising acrylate groups and/or methacrylate groups. The (meth)acrylate groups can, in principle, be linked to the polymer at any point in the polyurethane polymer or the additional units. For example, they can be part of a polyether or polyester (meth)acrylate polymer unit.

The polyurethane containing (meth)acrylate groups can be present and used as a powdered solid, as a melt, from solution or preferably as an aqueous dispersion. Aqueous dispersions offer the advantage of processing even particularly high molecular weight polyurethanes in a coating composition with low dynamic viscosity, since the viscosity is independent of the molecular weight of the components of the disperse phase in dispersions.

Suitable dispersions are e.g. polyurethane dispersions containing (meth)acrylate groups, alone or in a mixture with polyacrylate dispersions containing (meth)acrylate groups and/or low molecular weight compounds containing (meth)acrylate groups and/or dispersed polymers without acrylate or methacrylate groups.

According to the invention, it is provided that the polyurethane polymer containing (meth)acrylate groups is obtainable from the reaction of a reaction mixture comprising:
(a) polyisocyanates and
(b1) compounds which comprise (meth)acrylate groups and are reactive towards isocyanates.

Suitable polyisocyanates (a), which also include diisocyanates, are aromatic, araliphatic, aliphatic or cycloaliphatic polyisocyanates. Mixtures of these di- or polyisocyanates can also be used. Examples of suitable polyisocyanates are butylene diisocyanate, hexamethylene diisocyanate (HDI), isophorone diisocyanate (TPDI), 2,2,4- and/or 2,4,4-trimethylhexamethylene diisocyanate, the isomeric bis(4,4′-isocyanatocyclohexyl)methanes or mixtures thereof with any isomer content, isocyanatomethyl-1,8-octane diisocyanate, 1,4-cyclohexylene diisocyanate, 1,4-phenylene diisocyanate, 2,4- and/or 2,6-toluene diisocyanate, the isomeric xylene diisocyanates, 1,5-naphthylene diisocyanate, 2,4′- or 4,4′-diphenylmethane diisocyanate, triphenylmethane-4,4′,4″-triisocyanate or the derivatives thereof with a urethane, isocyanurate, allophanate, biuret, oxadiazine trione, uretdione or iminooxadiazine dione structure and mixtures thereof. Di- or polyisocyanates with a cycloaliphatic or aromatic structure are preferred, since a high proportion of these structural elements has a positive effect on the drying properties, particularly the blocking resistance of the coating before UV curing. Particularly preferred diisocyanates are isophorone diisocyanate and the isomeric bis(4,4′-isocyanatocyclohexyl)methanes and mixtures thereof.

The component (b1) preferably comprises hydroxyfunctional acrylates or methacrylates. Examples are 2-hydroxyethyl (meth)acrylate, polyethylene oxide mono(meth)acrylates, polypropylene oxide mono(meth)acrylates, polyalkylene oxide mono(meth)acrylates, poly(ε-caprolactone) mono(meth)acrylates, such as Pemcure® 12A (Cognis, Düsseldorf, DE), 2-hydroxypropyl(meth)acrylate, 4-hydroxybutyl(meth)acrylate, 3-hydroxy-2,2-dimethylpropyl(meth)acrylate, the acrylic acid and/or methacrylic acid partial esters of polyhydric alcohols, such as trimethylolpropane, glycerol, pentaerythritol, dipentaerythritol, sorbitol, ethoxylated, propoxylated or alkoxylated trimethylolpropane, glycerol, pentaerythritol, dipentaerythritol or technical mixtures thereof. Acrylated monoalcohols are preferred. Also suitable are alcohols which can be obtained from the reaction of double-bond-containing acids with optionally double-bond-containing, monomeric epoxy compounds, such as e.g. the reaction products of (meth)acrylic acid with glycidyl(meth)acrylate or with the glycidyl ester of Versatic acid.

In addition, isocyanate-reactive oligomeric or polymeric unsaturated (meth)acrylate group-containing compounds can be used alone or in combination with the aforementioned monomeric compounds. As component (b1) it is preferred to use hydroxyl-group-containing polyester acrylates with an OH content of ≧30 mg KOH/g to ≦300 mg KOH/g, preferably ≧60 mg KOH/g to ≦200 mg KOH/g, particularly preferably ≧70 mg KOH/g to ≦120 mg KOH/g. In the production of the hydroxyfunctional polyester acrylates, a total of 7 groups of monomer components can be used:
1. (Cyclo)alkane diols such as dihydric alcohols with (cyclo)aliphatically bound hydroxyl groups in the molecular weight range of ≧62 g/mol to ≦286 g/mol, e.g. ethanediol, 1,2- and 1,3-propanediol, 1,2-, 1,3- and 1,4-butanediol, 1,5-pentanediol, 1,6-hexanediol, neopentyl glycol, 1,4-cyclohexanedimethanol, 1,2- and 1,4-cyclohexanediol, 2-ethyl-2-butyl propanediol, diols containing ether oxygen, such as e.g. diethylene glycol, triethylene glycol, tetraethylene glycol, dipropylene glycol, tripropylene glycol, polyethylene glycols, polypropylene glycols or polybutylene glycols with a molecular weight of ≧200 g/mol to ≦4000 g/mol, preferably ≧300 g/mol to ≦2000 g/mol, particularly preferably ≧450 g/mol to ≦1200 g/mol. Reaction products of the aforementioned diols with ε-caprolactone or other lactones can also be employed as diols.
2. Trihydric and polyhydric alcohols in the molecular weight range of ≧92 g/mol to ≦254 g/mol, such as e.g. glycerol, trimethylolpropane, pentaerythritol, dipentaerythritol and sorbitol or polyethers started on these alcohols, such as e.g. the reaction product of 1 mol trimethylolpropane with 4 mol ethylene oxide.
3. Monoalcohols, such as e.g. ethanol, 1- and 2-propanol, 1- and 2-butanol, 1-hexanol, 2-ethylhexanol, cyclohexanol and benzyl alcohol.
4. Dicarboxylic acids in the molecular weight range of ≧104 g/mol to ≦600 g/mol and/or the anhydrides thereof, such as e.g. phthalic acid, phthalic anhydride, isophthalic acid, tetrahydrophthalic acid, tetrahydrophthalic anhydride, hexahydrophthalic acid, hexahydrophthalic anhydride, cyclohexanedicarboxylic acid, maleic anhydride, fumaric acid, malonic acid, succinic acid, succinic anhydride, glutaric acid, adipic acid, pimelic acid, suberic acid, sebacic acid, dodecanedioic acid, hydrogenated dimer fatty acids.
5. Polyfunctional carboxylic acids or their anhydrides, such as e.g. trimellitic acid and trimellitic anhydride.
6. Monocarboxylic acids, such as e.g. benzoic acid, cyclohexanecarboxylic acid, 2-ethylhexanoic acid, caproic acid, caprylic acid, capric acid, lauric acid, natural and synthetic fatty acids.
7. Acrylic acid, methacrylic acid or dimeric acrylic acid.

Suitable hydroxyl-group-containing polyester acrylates include the reaction product of at least one component from group 1 or 2 with at least one component from group 4 or 5 and at least one component from group 7.

Groups having a dispersing effect may optionally also be incorporated into these polyester acrylates. Thus, proportions of polyethylene glycols and/or methoxy polyethylene glycols may be jointly used as the alcohol component. Examples of compounds that may be mentioned are polyethylene glycols and polypropylene glycols started on alcohols and the block copolymers thereof, as well as the monomethyl ethers of these polyglycols. Polyethylene glycol 1500 monomethyl ether and/or polyethylene glycol 500 monomethyl ether is/are particularly suitable.

It is additionally possible to react a portion of carboxyl groups, particularly those of (meth)acrylic acid, with mono-, di- or polyepoxides after the esterification. For example, the epoxides (glycidyl ethers) of monomeric, oligomeric or polymeric bisphenol A, bisphenol F, hexanediol, butanediol and/or trimethylolpropane or their ethoxylated and/or propoxylated derivatives are preferred. This reaction can be used in particular to increase the OH number of the polyester(meth)acrylate, since an OH group is formed during the epoxide-acid reaction in each case. The acid number of the resulting product is between ≧0 mg KOH/g and ≦20 mg KOH/g, preferably between ≧0.5 mg KOH/g and ≦10 mg KOH/g and particularly preferably between ≧1 mg KOH/g and ≦3 mg KOH/g. The reaction is preferably catalysed by catalysts such as triphenylphosphine, thiodiglycol, ammonium and/or phosphonium halides and/or zirconium or tin compounds, such as tin(II) ethylhexanoate.

Also preferred as component (b1) are hydroxyl-group-containing epoxy (meth)acrylates with OH contents of ≧20 mg KOH/g to ≦300 mg KOH/g, preferably of ≧100 mg KOH/g to ≦280 mg KOH/g, particularly preferably of ≧150 mg KOH/g to ≦250 mg KOH/g, or hydroxyl-group-containing polyurethane(meth)acrylates with OH contents of ≧20 mg KOH/g to ≦300 mg KOH/g, preferably of ≧40 mg KOH/g to ≦150 mg KOH/g, particularly preferably of ≧50 mg KOH/g to ≦100 mg KOH/g, and mixtures thereof with one another and mixtures with hydroxyl-group-containing unsaturated polyesters as well as mixtures with polyester(meth)acrylates or mixtures of hydroxyl-group-containing unsaturated polyesters with polyester(meth)acrylates. Hydroxyl-group-containing epoxy(meth)acrylates are based particularly on reaction products of acrylic acid and/or methacrylic acid with epoxides (glycidyl compounds) of monomeric, oligomeric or polymeric bisphenol A, bisphenol F, hexanediol and/or butanediol or the ethoxylated and/or propoxylated derivatives thereof.

For the inorganic nanoparticles present in the coating, inorganic oxides, mixed oxides, hydroxides, sulfates, carbonates, carbides, borides and nitrides of elements of main groups II to IV and/or elements of subgroups I to VIII of the periodic table are suitable, including the lanthanides. Preferred particles are those of silicon oxide, aluminium oxide, cerium oxide, zirconium oxide, niobium oxide and titanium oxide, with silicon oxide nanoparticles being particularly preferred here.

The particles used have average particle sizes of ≧1 nm to ≦200 nm, preferably of ≧3 nm to ≦50 nm, particularly preferably of ≧5 nm to ≦7 nm. The average particle size can preferably be determined in dispersion by dynamic light scattering as a z-average. Below a particle size of 1 nm, the nanoparticles reach the size of the polymer particles. Such small nanoparticles may then lead to an increase in the viscosity of the coating, which is disadvantageous. Above a particle size of 200 nm, the particles may in some cases be perceived by the naked eye, which is undesirable.

Preferably ≧75%, particularly preferably ≧90%, most particularly preferably ≧95% of all particles used have the sizes defined above. As the coarse portion increases in the overall particles, the optical properties of the coating deteriorate and, in particular, haze can occur.

The particles can be selected such that the refractive index of their material corresponds to the refractive index of the cured radiation-curing coating. In this case, the coating exhibits transparent optical properties. For example, a refractive index in the range of ≧1.35 to ≦1.45 is advantageous.

The non-volatile proportions of the radiation-curing layer can make up the following quantitative proportions, for example. The nanoparticles can be present in quantities of ≧1 wt. % to ≦60 wt. %, preferably ≧5 wt. % to ≦50 wt. % and particularly of ≧10 wt. % to ≦40 wt. %. Additional compounds, such as e.g. monomeric crosslinking agents, can be present in a proportion of ≧0 wt. % to ≦40 wt. % and particularly of ≧15 wt. % to ≦20 wt. %. The polyurethane polymer can then make up the difference to 100 wt. %. In general, the guideline that the sum of the individual proportions by weight is ≦100 wt. % applies.

Suitable as the aforementioned (meth)acrylate-group-containing polyacrylate dispersions are so-called secondary dispersions or emulsion polymers which contain low molecular weight compounds comprising co-emulsified (meth)acrylate groups. Secondary dispersions are produced by free-radical polymerisation of vinyl monomers, such as e.g. styrene, acrylic acid, (meth)acrylic acid esters and the like, in a solvent which is inert in terms of the polymerisation, and are subsequently dispersed in water having been hydrophilically modified by internal and/or external emulsifiers. It is possible to incorporate (meth)acrylate groups by using monomers such as acrylic acid or glycidyl methacrylate in the polymerisation and reacting these before dispersing in a modification reaction with the complementary compound in terms of an epoxide-acid reaction, which contain (meth)acrylate groups such as e.g. acrylic acid or glycidyl methacrylate.

Emulsion polymers which contain co-emulsified low molecular weight compounds comprising (meth)acrylate groups are commercially available, e.g. Lux® 515, 805, 822 from Alberdingk & Boley, Krefeld, DE or Craymul® 2716, 2717 from Cray Valley, FR.

Polyacrylate dispersions with a high glass transition temperature are preferred, which have a positive effect on the drying properties of the coating before UV curing. A high proportion of co-emulsified low molecular weight compounds comprising (meth)acrylate groups can have a negative impact on the drying properties.

Suitable examples of the aforementioned dispersed polymers without acrylate or methacrylate groups are emulsion polymers as commercially available with the designation of Joncryl® (BASF AG, Ludwigshafen, DE), Neocryl (DSM Neoresins, Walwijk, NL) or Primal (Rohm & Haas Deutschland, Frankfurt, DE).

In another embodiment of the present invention, the weight average Mw of the polyurethane polymer is in a range of ≧250000 g/mol to ≦350000 g/mol. The molecular weight can be determined by gel permeation chromatography (GPC). The weight average Mw can also lie within a range from ≧280000 g/mol to ≦320000 g/mol or from ≧300000 g/mol to ≦310000 g/mol. Polyurethane dispersions with these molecular weights of the polymers can exhibit favourable touch-drying behaviour after application and also good blocking resistance after drying.

The glass transition temperature, particularly measured by differential scanning calorimetry (DSC), is often rather unsuitable for characterising the components of the radiation-curing layer. Owing to the lack of uniformity of the polymeric and oligomeric components, the presence of more uniform building blocks, such as e.g. polyester diols with average molecular weights of 2000, and the degrees of branching of the polymers, measured values for the glass transition temperature are often obtained which are not very meaningful. In particular, it is barely possible to define in a meaningful way a glass transition temperature for a binder that consists of an organic polyurethane polymer and inorganic nanoparticles (“inorganic polymers”). It is true, however, that an increase in components of an aromatic or cycloaliphatic nature in the polyurethane has a positive influence on the touch drying of the coating composition. Of course, there should still be film formation of the coating composition, if appropriate even with the addition of ≧3 wt. % to ≦15 wt. % solvents having a boiling point higher than that of water.

In another embodiment of the present invention, the reaction mixture also comprises the following components:
(b2) hydrophilically modified compounds with ionic groups and/or groups capable of conversion to ionic groups and/or nonionic groups
(b3) polyol compounds having an average molecular weight of ≧50 g/mol to ≦500 g/mol and a hydroxyl functionality of ≧2 and
(b4) aminofunctional compounds.

The component (b2) comprises ionic groups which may be either cationic or anionic by nature and/or nonionic hydrophilic groups. Compounds having a cationically, anionically or nonionically dispersing action are those which contain e.g. sulfonium, ammonium, phosphonium, carboxylate, sulfonate or phosphonate groups or the groups that can be converted to the aforementioned groups by salt formation (potentially ionic groups) or polyether groups, and which can be incorporated into the macromolecules by means of isocyanate-reactive groups that are present. Hydroxyl groups and amine groups are preferably suitable as isocyanate-reactive groups.

Suitable ionic or potentially ionic compounds (b2) are e.g. mono- and dihydroxycarboxylic acids, mono- and diaminocarboxylic acids, mono- and dihydroxysulfonic acids, mono- and diaminosulfonic acids and mono- and dihydroxyphosphonic acids or mono- and diaminophosphonic acids and their salts, such as dimethylolpropionic acid, dimethylolbutyric acid, hydroxypivalic acid, N-(2-aminoethyl)-β-alanine, 2-(2-aminoethylamino)ethane sulfonic acid, ethylenediamine propyl or butyl sulfonic acid, 1,2- or 1,3-propylenediamine-β-ethyl sulfonic acid, malic acid, citric acid, glycolic acid, lactic acid, glycine, alanine, taurine, N-cyclohexylaminopropiosulfonic acid, lysine, 3,5-diaminobenzoic acid, addition products of IPDI and acrylic acid and the alkali and/or ammonium salts thereof; the adduct of sodium bisulfite to 2-butene-1,4-diol, polyether sulfonate, the propoxylated adduct of 2-butenediol and NaHSO₃, as well as building blocks that can be converted to cationic groups, such as N-methyldiethanolamine, as hydrophilic constituents. Preferred ionic or potentially ionic compounds are those that have carboxy or carboxylate and/or sulfonate groups and/or ammonium groups. Particularly preferred ionic compounds are those that contain carboxyl and/or sulfonate groups as ionic or potentially ionic groups, such as the salts of N-(2-aminoethyl)-β-alanine, of 2-(2-aminoethylamino)ethanesulfonic acid or of the addition product of IPDI and acrylic acid (EP-A 0 916 647, example 1) and of dimethylolpropionic acid.

Suitable hydrophilically modified compounds are e.g. polyoxyalkylene ethers which contain at least one hydroxy or amino group. These polyethers contain a proportion of ≧30 wt. % to ≦100 wt. % of building blocks that are derived from ethylene oxide. Polyethers with a linear construction and a functionality of between ≧1 and ≦3 are suitable, but also compounds of the general formula (I),

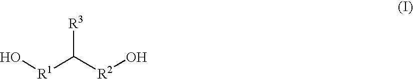

in which
R¹ and R² independently of one another each signify a divalent aliphatic, cycloaliphatic or aromatic group with 1 to 18 C atoms, which may be interrupted by oxygen and/or nitrogen atoms, and
R³ denotes an alkoxy-terminated polyethylene oxide group.

Compounds having a nonionically hydrophilically modifying action are e.g. also monohydric polyalkylene oxide polyether alcohols having a statistical average of ≧5 to ≦70, preferably ≧7 to ≦55 ethylene oxide units per molecule, as can be obtained by alkoxylation of suitable starter molecules.

Suitable starter molecules are e.g. saturated monoalcohols, such as methanol, ethanol, n-propanol, isopropanol, n-butanol, isobutanol, see.-butanol, the isomeric pentanols, hexanols, octanols and nonanols, n-decanol, n-dodecanol, n-tetradecanol, n-hexadecanol, n-octadecanol, cyclohexanol, the isomeric methyl cyclohexanols or hydroxymethyl cyclohexane, 3-ethyl-3-hydroxymethyloxetane or tetrahydrofurfuryl alcohol, diethylene glycol monoalkyl ethers, such as e.g. diethylene glycol monobutyl ether, unsaturated alcohols, such as allyl alcohol, 1,1-dimethyl allyl alcohol or oleic alcohol, aromatic alcohols, such as phenol, the isomeric cresols or methoxyphenols, araliphatic alcohols, such as benzyl alcohol, anise alcohol or cinnamyl alcohol, secondary monoamines, such as dimethylamine, diethylamine, dipropylamine, diisopropylamine, dibutylamine, bis(2-ethylhexyl)amine, N-methyl- and N-ethylcyclohexylamine or dicyclohexylamine, as well as heterocyclic secondary amines, such as morpholine, pyrrolidine, piperidine or 1H-pyrazole. Preferred starter molecules are saturated monoalcohols. Diethylene glycol monobutyl ether is particularly preferably used as starter molecule.

Alkylene oxides suitable for the alkoxylation reaction are in particular ethylene oxide and propylene oxide, which may be used in the alkoxylation reaction in any order or else in a mixture.

The polyalkylene oxide polyether alcohols are either pure polyethylene oxide polyethers or mixed polyalkylene oxide polyethers, the alkylene oxide units of which comprise ≧30 mole %, preferably ≧40 mole % ethylene oxide units. Preferred nonionic compounds are monofunctional mixed polyalkylene oxide polyethers having ≧40 mole % ethylene oxide and ≦60 mole % propylene oxide units.

The component (b2) preferably comprises ionic hydrophilising agents, since nonionic hydrophilising agents may have rather a negative effect on the drying properties and particularly on the blocking resistance of the coating before UV curing.

Suitable low molecular weight polyols (b3) are short-chain aliphatic, araliphatic or cycloaliphatic diols or triols preferably containing ≧2 to ≦20 carbon atoms. Examples of diols are ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positional isomers of diethyl octanediol, 1,3-butylene glycol, cyclohexanediol, 1,4-cyclohexanedimethanol, 1,6-hexanediol, 1,2- and 1,4-cyclohexanediol, hydrogenated bisphenol A (2,2-bis(4-hydroxycyclohexyl)propane) and 2,2-dimethyl-3-hydroxypropionic acid (2,2-dimethyl-3-hydroxypropyl ester). Preferred are 1,4-butanediol, 1,4-cyclohexanedimethanol and 1,6-hexanediol. Examples of suitable triols are trimethylolethane, trimethylolpropane or glycerol; trimethylolpropane is preferred.

The component (b4) can be selected from the group of the polyamines (which also includes diamines), which are used to increase the molecular weight and are preferably added towards the end of the polyaddition reaction. This reaction preferably takes place in an aqueous medium. The polyamines should therefore be more reactive than water towards the isocyanate groups of component (a). The following are mentioned as examples: ethylenediamine, 1,3-propylenediamine, 1,6-hexamethylenediamine, isophorone diamine, 1,3-, 1,4-phenylenediamine, 4,4′-diphenylmethanediamine, aminofunctional polyethylene oxides or polypropylene oxides, which are obtainable under the name Jeffamin®, D series (Huntsman Corp. Europe, Belgium), diethylenetriamine, triethylenetetramine and hydrazine. Isophorone diamine, ethylenediamine and 1,6-hexamethylenediamine are preferred. Ethylenediamine is particularly preferred.

Proportions of monoamines, such as e.g. butylamine, ethylamine and amines of the Jeffamin® M series (Huntsman Corp. Europe, Belgium), aminofunctional polyethylene oxides and polypropylene oxides can also be added.

In another embodiment, the reaction mixture also comprises the following component:
(b5) polyol compounds with an average molecular weight of ≧500 g/mol to ≦13000 g/mol and an average hydroxyl functionality of ≧1.5 to ≦5.

Suitable higher molecular weight polyols (b5) are polyols (also including diols) with a number average molecular weight in the range of ≧500 g/mol to ≦13000 g/mol, preferably ≧700 g/mol to ≦4000 g/mol. Preferred are polymers with an average hydroxyl functionality of ≧1.5 to ≦2.5, preferably of ≧1.8 to ≦2.2, particularly preferably of ≧1.9 to ≦2.1. These include for example polyester alcohols based on aliphatic, cycloaliphatic and/or aromatic di-, tri- and/or polycarboxylic acids with di-, tri- and/or polyols as well as lactone-based polyester alcohols. Preferred polyester alcohols are e.g. reaction products of adipic acid with hexanediol, butanediol or neopentyl glycol or mixtures of said diols having a molecular weight of ≧500 g/mol to ≦4000 g/mol, particularly preferably ≧800 g/mol to ≦2500 g/mol. Also suitable are polyetherols which are obtainable by polymerisation of cyclic ethers or by reaction of alkylene oxides with a starter molecule. The polyethylene and/or polypropylene glycols having an average molecular weight of ≧500 g/mol to ≦13000 g/mol may be mentioned by way of example, as well as polytetrahydrofurans having an average molecular weight of ≧500 g/mol to ≦8000 g/mol, preferably of ≧800 g/mol to ≦3000 g/mol.

Also suitable are hydroxyl-terminated polycarbonates, which are obtainable by reaction of diols or lactone-modified diols or bisphenols, such as e.g. bisphenol A, with phosgene or carbonic acid diesters, such as diphenyl carbonate or dimethyl carbonate. The polymeric carbonates of 1,6-hexanediol with an average molecular weight of ≧500 g/mol to ≦8000 g/mol may be mentioned by way of example, as well as the carbonates of reaction products of 1,6-hexanediol with ε-caprolactone in a molar ratio of ≧0.1 to ≦1. The aforementioned polycarbonate diols having an average molecular weight of ≧800 g/mol to ≦3000 g/mol based on 1,6-hexanediol and/or carbonates of reaction products of 1,6-hexanediol with ε-caprolactone in a molar ratio of ≧0.33 to ≦1 are preferred. Hydroxyl-terminated polyamide alcohols and hydroxyl-terminated polyacrylate diols can also be used.

In another embodiment, the number of hydroxyl groups in component (b3) in the reaction mixture represents a proportion of the total amount of hydroxyl groups and amino groups of ≧5 mole % to ≦25 mole %, wherein the hydroxyl groups of water in the reaction mixture are not taken into account here. This proportion can also be in a range of ≧10 mole % to ≦20 mole % or of ≧14 mole % to ≦18 mole %. This means that the number of OH groups in component (b3) is within the ranges mentioned in all of the compounds carrying OH and NH₂ groups, i.e. in all of components (b1), (b2), (b3) and (b4) and, where (b5) is also present, in all of components (b1), (b2), (b3), (b4) and (b5). Water is not taken into account in the calculation. The proportion of the component (b3) can be used to influence the degree of branching of the polymer, with a higher degree of branching being advantageous. This can improve the touch-drying behaviour of the coating.

Moreover, touch-drying is improved by the highest possible number of the strongest possible hydrogen group bonds between the molecules of the coating. Urethane, urea and esters, particularly carbonate esters, are examples of structural units which support touch-drying the higher the number in which they are incorporated.

In another embodiment, the coating also comprises the following component:
(b6) compounds which comprise (meth)acrylate groups and are non-reactive towards isocyanates and/or have not been reacted.

These compounds are used to increase the double bond density of the coating. A high double bond density increases the performance characteristics (resistance to mechanical or chemical influences) of the UV-cured coating. However, they have an effect on the drying properties. For this reason, they are used in a quantity of preferably ≧1 wt. % to ≦35 wt. %, particularly ≧5 wt. % to ≦25 wt. % and most particularly preferably ≧10 wt. % to ≦20 wt. % of the total solids of the coating composition. In the UV-curing coating compositions industry, these compounds are also referred to as reactive thinners.

In another embodiment, the surface of the nanoparticles in the coating is modified by the covalent and/or non-covalent attachment of other compounds.

A preferred covalent surface modification is silanisation with alkoxysilanes and/or chlorosilanes. Partial modification with γ-glycidoxypropyltrimethoxysilane is particularly preferred.

An example of the non-covalent case is an adsorptive/associative modification using surfactants or block copolymers.

In addition, it is possible that the compounds which are covalently and/or non-covalently bonded to the surface of the nanoparticles also contain carbon-carbon double bonds. (Meth)acrylate groups are preferred in this case. In this way, the nanoparticles can be bound into the binder matrix even more strongly during radiation curing.

It is also possible to add to the coating composition which is dried to form the radiation-curing layer so-called crossing agents, which are intended to improve the touch-drying and possibly the adhesion of the radiation-curing layer. Polyisocyanates, polyaziridines and polycarbodiimides are preferably suitable. Hydrophilically modified polyisocyanates are particularly preferred for aqueous coating compositions. The quantity and functionality of the crosslinking agents should be adapted to the film, particularly in respect of the desired deformability. In general, ≦10 wt. % of solid crosslinking agent is added, based on the solids content of the coating composition. Many of the possible crosslinking agents reduce the storage life of the coating composition since they already react slowly in the coating composition. The addition of the crosslinking agents should therefore take place an appropriately short time before application. Hydrophilically modified polyisocyanates are available, e.g. with the designations Bayhydur® (Bayer MaterialScience AG, Leverkusen, DE) and Rhodocoat® (Rhodia, F). When a crosslinking agent is added, the time and temperature required for optimum touch-drying to be achieved may be increased.

In addition, the radiation-curing layer or the coating composition with the aid of which the layer is produced may contain the additives and/or auxiliary substances and/or solvents conventional in the technology of lacquers, paints and printing inks. Examples of these are described below.

Photoinitiators that are added are initiators capable of activation by actinic radiation, which trigger free-radical polymerisation of the appropriate polymerisable groups.

Photoinitiators are commercially marketed compounds which are known per se, with a differentiation being made between unimolecular (type I) and bimolecular (type II) initiators. (Type I) systems are e.g. aromatic ketone compounds, e.g. benzophenones in combination with tertiary amines, alkyl benzophenones, 4,4′-bis(dimethylamino)benzophenone (Michier's ketone), anthrone and halogenated benzophenones or mixtures of the above types. Also suitable are (type II) initiators, such as benzoin and its derivatives, benzil ketals, acyl phosphine oxides, e.g. 2,4,6-trimethylbenzoyl diphenylphosphine oxide, bisacyl phosphine oxides, phenylglyoxylic acid ester, camphorquinone, α-aminoalkylphenones, α,α-dialkoxy-acetophenones and α-hydroxyalkylphenones. It may also be advantageous to use mixtures of these compounds. Suitable initiators are commercially available, e.g. with the designations Irgacure® and Darocur® (Ciba, Basel, CH) and Esacure® (Fratelli Lamberti, Adelate, IT).

In particular, these are stabilisers, light stabilisers such as UV absorbers and sterically hindered amines (HALS), as well as antioxidants and paint additives, e.g. anti-settling agents, defoamers and/or wetting agents, flow promoters, plasticisers, antistatic agents, catalysts, co-solvents and/or thickeners as well as pigments, dyes and/or flatting agents.

Suitable solvents are water and/or other common solvents from coating technology, adapted to the binders used and to the application method. Examples are acetone, ethyl acetate, butyl acetate, methoxypropyl acetate, diacetone alcohol, glycols, glycol ether, water, xylene or solvent naphtha from Exxon-Chemie as aromatic-containing solvent, as well as mixtures of said solvents.

In addition, fillers and non-functional polymers may be contained to adjust the mechanical, haptic, electrical and/or optical properties. All polymers and fillers that are compatible and miscible with the coating composition are suitable for this purpose.

Suitable polymer additives are polymers such as e.g. polycarbonates, polyolefins, polyethers, polyesters, polyamides and polyureas.

Mineral fillers, particularly so-called flatting agents, glass fibres, carbon blacks, carbon nanotubes (e.g. Baytubes®, Bayer MaterialScience AG, Leverkusen) and/or metallic fillers, as used for so-called metallic paint finishes, can be employed as fillers.

The invention also provides a process for the production of coated films according to the present invention, comprising the following steps:
preparation of a polymer dispersion, wherein the dispersion comprises a polyurethane polymer which contains (meth)acrylate groups and which is obtainable from the reaction of a reaction mixture comprising:
   (a) polyisocyanates and
   (b1) compounds which comprise (meth)acrylate groups and are reactive towards isocyanates
and wherein the dispersion also comprises inorganic nanoparticles with an average particle size of ≧1 nm to ≦200 nm
coating of a film with the polymer dispersion
drying of the polymer dispersion.

The preparation of the polymer dispersion takes place by means of the polymer-forming reaction and the dispersing of the polyurethane polymer in water.

The reaction mixture can further comprise the aforementioned additional components, i.e. in particular (b2), (b3), (b4), (b5) and (b6) in addition to photoinitiators, additives and co-solvents. These components may be present in a reaction mixture according to the invention e.g. in the following quantitative proportions, the sum of the individual proportions by weight adding up to ≦100 wt. %:
(a): ≧5 wt. % to ≦50 wt. %, preferably ≧20 wt. % to ≦40 wt. %, more preferably ≧25 wt. % to ≦35 wt. %.
(b1): ≧10 wt. % to ≦80 wt. %, preferably ≧30 wt. % to ≦60 wt. %, more preferably ≧40 wt. % to ≦50 wt. %.
(b2): ≧0 wt. % to ≦20 wt. %, preferably ≧2 wt. % to ≦15 wt. %, more preferably ≧3 wt. % to ≦10 wt. %.
(b3): ≧0 wt. % to ≦25 wt. %, preferably ≧0.5 wt. % to ≦15 wt. %, more preferably ≧1 wt. % to ≦5 wt. %.
(b4): ≧0 wt. % to ≦20 wt. %, preferably ≧0.5 wt. % to ≦10 wt. %, more preferably ≧1 wt. % to ≦5 wt. %.
(b5): ≧0 wt. % to ≦50 wt. %, preferably =0 wt. %.
(b6): ≧0 wt. % to ≦40 wt. %, preferably ≧5 wt. % to ≦30 wt. %, more preferably ≧10 wt. % to ≦25 wt. %.

The reaction products from the reaction mixture are taken up in water to produce an aqueous dispersion. The proportion of the polyurethane polymer in the water may be in a range of ≧10 wt. % to ≦75 wt. %, preferably ≧15 wt. % to ≦55 wt. %, more preferably ≧25 wt. % to ≦40 wt. %.

The proportion of nanoparticles in the aqueous dispersion may be in a range of ≧5 wt. % to ≦60 wt. %, preferably ≧10 wt. % to ≦40 wt. %, more preferably ≧15 wt. % to ≦30 wt. %.

The production of a polyurethane dispersion as an example of a coating of a film according to the invention may be carried out in one or more steps in a homogeneous phase or, in the case of a multi-step reaction, partly in the disperse phase. After polyaddition has been completely or partly carried out, a dispersing step takes place. Following this, a further polyaddition or a modification optionally takes place in the disperse phase.

To produce the polyurethane dispersion, processes such as e.g. emulsifier-shear force, acetone, prepolymer mixing, melt emulsifying, ketimine and spontaneous solids dispersing methods or derivatives thereof may be used. The melt emulsifying and the acetone methods, as well as mixed variants of these two processes, are preferred.

In general, the components (b1), (b2), (b3) and (b5), which contain no primary or secondary amino groups, and a polyisocyanate (a) are placed in the reactor in their entirety or in part to produce a polyurethane prepolymer and are optionally diluted with a solvent which is water-miscible but inert towards isocyanate groups, but preferably without solvents, and heated to elevated temperatures, preferably in the range of ≧50° C. to ≦120° C.

Suitable solvents are e.g. acetone, butanone, tetrahydrofuran, dioxane, acetonitrile, dipropylene glycol dimethyl ether and 1-ethyl- or 1-methyl-2-pyrrolidone, which may be added not only at the beginning of production but optionally also later in portions. Acetone and butanone are preferred. In general, at the beginning of the reaction, only solvents for ≧60 wt. % to ≦97 wt. %, preferably ≧70 wt. % to ≦85 wt. % solids content are added. Depending on the process variant, particularly when complete conversion is to take place before dispersing, the addition of further solvent may be useful as the reaction progresses.

It is possible to carry out the reaction under standard pressure or elevated pressure, e.g. above the standard-pressure boiling point of a solvent such as e.g. acetone.

In addition, to accelerate the isocyanate addition reaction, catalysts such as e.g. triethylamine, 1,4-diazabicyclo-[2,2,2]-octane, tin dioctoate, bismuth octoate or dibutyltin dilaurate may be included in the initial charge or metered in later. Dibutyltin dilaurate (DBTL) is preferred. In addition to catalysts, the addition of stabilisers which protect the (meth)acrylate groups from spontaneous, undesirable polymerisation may also be useful. The compounds having (meth)acrylate groups that are used generally already contain such stabilisers.

Any of the components (a) and/or (b1), (b2), (b3) and (b5) which do not contain any primary or secondary amino groups and which have not yet been added at the beginning of the reaction are then metered in. In the production of the polyurethane prepolymer, the mole ratio of isocyanate groups to isocyanate-reactive groups is ≧0.90 to ≦3, preferably ≧0.95 to ≦2, particularly preferably ≧1.05 to ≦1.5. The reaction of the components (a) with (b) takes place partly or completely, based on the total amount of isocyanate-reactive groups of the portion of (b) which contains no primary or secondary amino groups, but preferably completely. The degree of conversion is generally monitored by tracking the NCO content of the reaction mixture. For this purpose it is possible to perform both spectroscopic measurements, e.g. infrared or near infrared spectra, refractive index determinations and chemical analyses such as titrations, on samples that have been taken. Polyurethane prepolymers, which may contain free isocyanate groups, are obtained in substance or in solution.

After or during the production of the polyurethane prepolymers from (a) and (b), if this has not already been carried out in the starting molecules, the partial or complete salt formation of the groups having an anionically and/or cationically dispersing action takes place. In the case of anionic groups, bases such as ammonia, ammonium carbonate or ammonium hydrogencarbonate, trimethylamine, triethylamine, tributylamine, diisopropylethylamine, dimethylethanolamine, diethylethanolamine, triethanolamine, ethylmorpholine, potassium hydroxide or sodium carbonate are used for this purpose, preferably triethylamine, triethanolamine, dimethylethanolamine or diisopropylethylamine. The amount of substance of the bases is between ≧50% and ≦100%, preferably between ≧60% and ≦90% of the amount of substance of the anionic groups. In the case of cationic groups, for example sulfuric acid dimethyl ester, lactic acid or succinic acid are used. If only non-ionically hydrophilically modified compounds (b2) with ether groups are used, the neutralisation step is omitted. Neutralisation can also take place at the same time as the dispersing, in that the dispersing water already contains the neutralising agent.

Any isocyanate groups still remaining are converted by reaction with amine components (b4) and/or, if present, amine components (b2) and/or water. This chain extension can take place either in solvent before dispersing or in water after dispersing. If amine components are contained in (b2), the chain extension preferably takes place before dispersing.

The amine component (b4) and/or, if present, the amine component (b2) can be added to the reaction mixture diluted with organic solvents and/or water. Preferably ≧70 wt. % to ≦95 wt. % solvent and/or water are used. If several amine components (b2) and/or (b4) are present, the reaction can take place consecutively in any order or simultaneously by adding a mixture.

During or following the production of the polyurethane, the optionally surface-modified nanoparticles are introduced. This can take place simply by stirring in the particles. However, it is also conceivable to use relatively high dispersing energy, as can take place e.g. by ultrasound, jet dispersion or high-speed stirrers according to the rotor-stator principle. Simple mechanical stirring is preferred.

In principle, the particles may be used both in powder form and in the form of colloid suspensions or dispersions in suitable solvents. The inorganic nanoparticles are preferably used in the form of colloid dispersions in organic solvents (organosols) or particularly preferably in water.

Suitable solvents for the organosols are methanol, ethanol, i-propanol, acetone, 2-butanone, methyl isobutyl ketone, butyl acetate, ethyl acetate, 1-methoxy-2-propyl acetate, toluene, xylene, 1,4-dioxane, diacetone alcohol, ethylene glycol n-propyl ether or any mixtures of these solvents. Suitable organosols have a solids content of ≧10 wt. % to ≦60 wt. %, preferably ≧15 wt. % to ≦50 wt. %. Suitable organosols are e.g. silicon dioxide organosols, as are obtainable e.g. with the trade names Organosilicasol® and Suncolloid® (Nissan Chem. Am. Corp.) or with the designation Highlink® NanO G (Clariant GmbH).

In so far as the nanoparticles are used in organic solvents (organosols), these are blended with the polyurethanes during their production before they are dispersed with water. The resulting mixtures are then dispersed by adding water or by transferring into water. The organic solvent of the organosol can be removed by distillation as required before or after dispersing with water, preferably after dispersing with water.

Within the meaning of the present invention, it is further preferred to use inorganic particles in the form of their aqueous preparations. The use of inorganic particles in the form of aqueous preparations of surface-modified inorganic nanoparticles is particularly preferred. These can be modified by silanisation for example before or at the same time as being incorporated into the silane-modified, polymeric organic binder or an aqueous dispersion of the silane-modified, polymeric organic binder.

Preferred aqueous, commercial nanoparticle dispersions are obtainable with the designations Levasil® (H.C. Starck GmbH, Goslar, Germany) and Bindzil® (EKA Chemical AB, Bohus, Sweden). Aqueous dispersions of Bindzil® CC 15, Bindzil® CC 30 and Bindzil® CC 40 from EKA (EKA Chemical AB, Bohus, Sweden) are particularly preferably used.

In so far as the nanoparticles are used in aqueous form, these are added to the aqueous dispersions of the polyurethanes. In another embodiment, instead of water the aqueous nanoparticle dispersion, preferably her diluted with water, is used in the production of the polyurethane dispersions.

For the purpose of producing the polyurethane dispersion, the polyurethane prepolymers are either added to the dispersing water, optionally under strong shear, such as e.g. vigorous stirring, or conversely the dispersing water is stirred into the prepolymer. Subsequently, if this has not already taken place in the homogeneous phase, the increase in molecular weight can then take place by reaction of any isocyanate groups that may be present with the component (b4). The amount of polyamine (b4) used depends on the unreacted isocyanate groups still present. Preferably ≧50% to ≦100%, particularly preferably ≧75% to ≦95% of the amount of substance of the isocyanate groups are reacted with polyamines (b4).

The resulting polyurethane-polyurea polymers have an isocyanate content of ≧0 wt. % to ≦2 wt %, preferably of ≧0 wt. % to ≦0.5 wt. %, particularly 0 wt. %.

The organic solvent may optionally be distilled off. The dispersions can then have a solids content of ≧20 wt. % to ≦70 wt. %, preferably ≧30 wt. % to ≦55 wt. %, particularly ≧35 wt. % to ≦45 wt. %.

The coating of a film with the polymer dispersion preferably takes place by roller coating, knife coating, flow coating, spraying or flooding. Printing processes, dipping, transfer processes and brushing are also possible. The application should take place with the exclusion of radiation which may lead to premature polymerisation of the acrylate and/or methacrylate double bonds of the polyurethane.

The drying of the polymer dispersion follows the application of the coating composition on to the film. For this purpose, work is carried out particularly at elevated temperatures in ovens and with moving and optionally also dehumidified air (convection ovens, jet dryers) as well as heat radiation (IR, NIR). Microwaves may also be used. It is possible and advantageous to combine several of these drying processes.

The conditions for drying are advantageously selected such that no polymerisation (crosslinking) of the acrylate or methacrylate groups is triggered by the elevated temperature and/or heat radiation, since this can have a negative effect on deformability. Furthermore, the maximum temperature reached should usefully be selected to be sufficiently low that the film does not deform in an uncontrolled manner.

After the drying/curing step, the coated film can be rolled up, optionally after laminating with a protective film on the coating. The rolling up can take place without adhesion of the coating to the reverse of the substrate film or laminating film taking place. However, it is also possible to cut the coated film to size and to feed the blanks on to further processing individually or as a stack.

The present invention also relates to the use of coated films according to the invention for the production of shaped articles. The films produced according to the invention are valuable materials for the production of consumer articles. Thus, the film can be used in the production of vehicle add-on parts, plastics parts such as panels for vehicle (interior) construction and/or aircraft (interior) construction, furniture construction, electronic devices, communication devices, housings and decorative articles.

The present invention also relates to a process for the production of shaped articles with a radiation-cured coating, comprising the following steps:
preparation of a coated film according to the present invention
forming the shaped article
curing the radiation-curing coating.

In this process, the coated film is brought into the desired final shape by thermal deformation. This can take place by processes such as thermoforming, vacuum forming, compression moulding or blow moulding.

After the deformation step, the coating of the film undergoes final curing by irradiation with actinic radiation.

Curing with actinic radiation is understood to be the free-radical polymerisation of ethylenically unsaturated carbon-carbon double bonds by means of initiator radicals which are released by irradiating with actinic radiation, e.g. from the photoinitiators described above.

The radiation curing preferably takes place through the impact of high-energy radiation, i.e. UV radiation or daylight, e.g. light at a wavelength of ≧200 nm to ≦750 nm, or by irradiating with high-energy electrons (electron beam, e.g. of ≧90 keV to ≦300 keV). Examples of radiation sources for light or UV light are medium- or high-pressure mercury vapour lamps, wherein the mercury vapour may be modified by doping with other elements such as gallium or iron. Lasers, pulsed lamps (known as UV flash lamps), halogen lamps or excimer lamps may also be used. The lamps may be installed in a fixed position so that the material to be irradiated is moved past the radiation source using a mechanical device, or the lamps may be movable and the material to be irradiated does not change its position during the curing. The radiation dose generally sufficient for crosslinking with UV curing is in the range of ≧80 mJ/cm² to ≦5000 mJ/cm².

The irradiation may optionally also take place with the exclusion of oxygen, e.g. under an inert gas atmosphere or oxygen-reduced atmosphere. Suitable as inert gases are preferably nitrogen, carbon dioxide, noble gases or combustion gases. Furthermore, the irradiation can take place by covering the coating with media which are transparent to radiation. Examples of these are e.g. polymer films, glass or liquids such as water.

Depending on the radiation dose and curing conditions, the type and concentration of the optionally used initiator should be varied or optimised in a manner known to the person skilled in the art or by preliminary tests. For the curing of the deformed films it is particularly advantageous to carry out the curing with several lamps, the arrangement of which should be selected such that each point of the coating obtains, as far as possible, the optimum dose and intensity of radiation for curing. In particular, non-irradiated areas (shadow zones) should be avoided.

In addition, depending on the film used, it may be advantageous to select the irradiation conditions such that the thermal load on the film does not become too great. In particular thin films and films made of materials with a low glass transition temperature may have a tendency towards uncontrolled deformation if a certain temperature is exceeded by the irradiation. In these cases it is advantageous to allow as little infrared radiation as possible to act on the substrate by using suitable filters or through the design of the lamps. Furthermore, it is possible to counteract uncontrolled deformation by reducing the appropriate radiation dose. However, it should be borne in mind here that a certain dose and intensity of irradiation are necessary for polymerisation to be as complete as possible. In these cases it is particularly advantageous to cure under inert or oxygen-reduced conditions since, when the proportion of oxygen in the atmosphere above the coating is reduced, the dose required for curing becomes lower.

Mercury lamps in fixed units are particularly preferably used for curing. Photoinitiators are used in this case in concentrations of ≧0.1 wt. % to ≦10 wt. %, particularly preferably ≧0.2 wt. % to ≦3.0 wt. %, based on the solids in the coating. To cure these coatings it is preferable to use a dose of ≧80 mJ/cm² to ≦5000 mJ/cm².

The resulting cured, coated, deformed film exhibits very good resistances to solvents and staining liquids as found in the household, as well as high hardness, good scratch resistance and good abrasion resistance with high optical transparency.

In one embodiment, the forming of the shaped article takes place in a mould under a pressure of ≧20 bar to ≦150 bar. In this high-pressure forming process, the pressure is preferably in a range from ≧50 bar to ≦120 bar or in a range from ≧90 bar to ≦110 bar. The pressure to be applied is determined particularly by the thickness of the film to be deformed and the temperature as well as the film material employed.

In another embodiment, the forming of the shaped article takes place at a temperature of ≧20° C. to ≦60° C. below the softening point of the material of the film. This temperature is preferably ≧30° C. to ≦50° C. or ≧40° C. to ≦45° C. below the softening point. This procedure, which is comparable with cold forming, has the advantage that thinner films, which lead to more precise shaping, can be used. Another advantage lies in shorter cycle times as well as lower thermal loading of the coating. These deformation temperatures are advantageously used in combination with a high-pressure forming process.

In another embodiment, the process also comprises the following step:
application of a polymer onto the side of the film opposite the cured layer.

The deformed coated film can be modified before or preferably after the final cure by processes such as e.g. back injection moulding or foaming in place with optionally filled polymers such as thermoplastics or reactive polymers such as two-component polyurethane systems. An adhesive layer may optionally also be used as an adhesion promoter in this case. Shaped articles result which have excellent performance characteristics where their surface is formed by the cured coating on the film.

The invention also provides a shaped article which can be produced by a process according to the present invention. Such shaped articles may be, for example, vehicle add-on parts, plastics parts such as panels for vehicle (interior) construction and/or aircraft (interior) construction, furniture construction, electronic devices, communication devices, housings or decorative articles.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

The present invention is explained further with the aid of the following examples. The units used in these examples have the following meanings:

Acid number: given in mg KOH/g sample, titration with 0.1 mol/l NaOH solution against bromothymol blue (ethanolic solution), colour change from yellow via green to blue, based on DIN 3682.

Hydroxyl number: given in mg KOH/g sample, titration with 0.1 mol/l meth. KOH solution after cold acetylation with acetic anhydride catalysed by dimethylaminopyridine, based on DIN 53240.

Isocyanate content: given in %, back titration with 0.1 mol/l hydrochloric acid after reaction with butylamine, based on DIN EN ISO 11909.

Gel permeation chromatography (GPC): eluting agent N,N-dimethylacetamide, RI detection, 30° C., integration after calibration with polystyrene standards.

Viscosities: rotational viscometer (Haake, type VT 550), measurements at 23° C. and shear gradient—unless otherwise specified—D 1/40 s⁻¹.

Unless otherwise specified, percentages given in the examples are wt. %.

In the examples, the compounds listed under their trade names have the following meanings:

Laromer PE 44 F: polyester acrylate with an OH number of approx. 85 mg KOH/g

Desmodur W: cycloaliphatic diisocyanate (methylene bis-4-isocyanatocyclohexane)

Photomer 4399: dipentaerythritol monohydroxypentaacrylate

Bayhydrol XP2648: aliphatic, polycarbonate-containing, anionic polyurethane dispersion, solvent-free

Bindzil CC40: amorphous silica, aqueous colloidal solution

Irgacure 500: mixture of equal proportions by weight of 1-hydroxycyclohexyl phenyl ketone and benzophenone

TegoGlide 410: organo-modified polysiloxane

BYK 346: solution of a polyether-modified siloxane

Bayhydur 305: hydrophilic, aliphatic polyisocyanate based on hexamethylene diisocyanate

DBTL: dibutyltin dilaurate

DAA: diacetone alcohol, 4-hydroxy-4-methylpentan-2-one

### Particle Size Determination:

The particle sizes were determined by means of dynamic light scattering using an HPPS particle size analyser (Malvern, Worcestershire, UK). The evaluation took place using Dispersion Technology Software 4,10. To avoid multiple scattering, a highly dilute dispersion of the nanoparticles was prepared. One drop of a dilute nanoparticle dispersion (approx. 0.1-10%) was placed into a cuvette containing approx. 2 ml of the same solvent as the dispersion, shaken and measured in an HPPS analyser at 20 to 25° C. As is general knowledge to the person skilled in the art, the relevant parameters of the dispersing medium—temperature, viscosity and refractive index—were entered into the software beforehand. In the case of organic solvents the cuvette used was made of glass. The result obtained was a plot of intensity and/or volume against particle diameter, and also the z-average for the particle diameter. Care was taken to ensure that the polydispersity index was <0.5.

### Production of the UV-Curing Polyurethane Dispersion UV-1 According to the Invention:

In a reaction vessel with stirrer, internal thermometer and gas feed (air flow 1 l/h), 471.9 parts of the polyester acrylate Laromer® PE 44 F (BASF AG, Ludwigshafen, DE), 8.22 parts trimethylolpropane, 27.3 parts dimethylolpropionic acid, 199.7 parts Desmodur® W (cycloaliphatic diisocyanate; Bayer MaterialScience AG, Leverkusen, DE) and 0.6 parts dibutyltin dilaurate were dissolved in 220 parts acetone and reacted up to an NCO content of 1.47 wt. % at 60° C. with stirring. 115.0 parts of the dipentaerythritol monohydroxypentaacrylate Photomer® 4399 (Cognis AG, Düsseldorf, DE) were added to the prepolymer solution thus obtained and stirred in.

The mixture was then cooled to 40° C. and 19.53 g triethylamine were added. After stirring for 5 min at 40° C., the reaction mixture was poured into 1200 g water at 20° C. while stirring rapidly. 9.32 g ethylenediamine in 30.0 g water were then added.

After continuing to stir for 30 min without heating or cooling, the product was distilled in vacuo (50 mbar, max. 50° C.) until a solids content of 40±1 wt. % was reached.

The dispersion had a pH value of 8.7 and a z-average for the particle diameter of 130 nm. The efflux time in a 4 mm flow cup was 18 s. The weight average molecular weight Mw of the polymer obtained was determined as 307840 g/mol.

### Formulation Examples

### Production of Coating Compositions

The production of the coating solutions described below was accomplished in two steps in order to guarantee complete compatibility of all components.

First, the solvents (LM) were placed in a stirred vessel with a stirrer and mixing unit. The additives (A) were then added consecutively at 500 rpm and stirring was performed until the respective additive had dissolved homogeneously. Finally, stirring was performed for 5 min.

In a second stirred vessel with a stirrer and mixing unit, a binder (BM—item 1 in the following examples) was initially charged. All the other binders (BM), optionally nanoparticles (NP) and crosslinking agents (V) were then added consecutively at 500 rpm and homogenised for 5 min each. The respective additive solution was then added with constant stirring and the formulation homogenised for a further 10 min. The coating solutions produced in this way were filtered through a filter cartridge before application (e.g. Pall HDC® II filter—pore size 1.2 μm or Sartorius Minisart® filter 17593—pore size 1.2 μm).

The function of the raw materials used and their abbreviations in the examples are explained further in the following table.

| | | Abbre- | |
|---|---|---|---|
| Name | Manufacturer | viation | Function |
| UV-1 | | BM | Binder |
| Bayhydrol XP2648 | Bayer MaterialScience | BM | Binder |
| | AG | | |
| Bindzil ® CC40 | Eka Chemicals AB | NP | Particles |
| Irgacure 500 | Ciba AG | A | Photoinitiator |
| TegoGlide 410 | Evonik Tego Chemie | A | Flow promoter |
| | GmbH | | |
| BYK 346 | BYK Chemie | A | Wetting agent |
| Diacetone alcohol | Kraemer & Martin | LM | Solvent |
| | GmbH | | |
| 2-Methoxypropanol | Kraemer & Martin | LM | Solvent |
| | GmbH | | |
| DBTL | Sigma Aldrich | A | Catalyst |
| Bayhydur 305 | Bayer MaterialScience | V | Crosslinking |
| | AG | | agent |

### Example 1

Formulation of an aqueous, physically drying and UV-curing coating composition based on UV-1

| Item | | Starting material | Manufacturer | Content | |
|---|---|---|---|---|---|
| 1 | BM | UV-1 | | 88.4 | g |
| 2 | A | Irgacure 500 | Ciba AG | 0.8 | g |
| 3 | A | TegoGlide 410 | Evonik Tego Chemie | 0.5 | g |
| | | | GmbH | | |
| 4 | A | BYK 346 | BYK Chemie | 0.3 | g |
| 5 | LM | Diacetone alcohol | Kraemer & Martin GmbH | 5.0 | g |
| 6 | LM | 2-Methoxypropanol | Kraemer & Martin GmbH | 5.0 | g |

| | | |
|---|---|---|
| Total | 100.0 | g |

### Example 2

Formulation of an aqueous, physically drying and UV-curing coating composition based on UV-1 and addition of Bindzil® CC40 (Eka Chemicals AB)

| Item | | Starting material | Manufacturer | Content | |
|---|---|---|---|---|---|
| 1 | BM | UV-1 | | 61.8 | g |
| 2 | NP | Bindzil ® CC40 | Eka Chemicals AB | 26.6 | g |
| 3 | A | Irgacure 500 | Ciba AG | 0.8 | g |
| 4 | A | TegoGlide 410 | Evonik Tego Chemie | 0.5 | g |
| | | | GmbH | | |
| 5 | A | BYK 346 | BYK Chemie | 0.3 | g |
| 6 | LM | Diacetone alcohol | Kraemer & Martin GmbH | 5.0 | g |
| 7 | LM | 2-Methoxypropanol | Kraemer & Martin GmbH | 5.0 | g |

| | | |
|---|---|---|
| Total | 100.0 | g |

### Example 3

Formulation of an aqueous, physically drying and UV-curing coating composition based on UV-1, Bayhydrol XP2648 (BMS AG) and addition of Bindzil® CC40 (Eka Chemicals AB)

| Item | | Starting material | Manufacturer | Content | |
|---|---|---|---|---|---|
| 1 | BM | UV-1 | | 56.3 | g |
| 2 | BM | Bayhydrol XP2648 | Bayer Material Science AG | 9.1 | g |
| 3 | NP | Bindzil ® CC40 | Eka Chemicals AB | 24.2 | g |
| 4 | A | Irgacure 500 | Ciba AG | 0.7 | g |
| 5 | A | TegoGlide 410 | Evonik Tego Chemie | 0.4 | g |
| | | | GmbH | | |
| 6 | A | BYK 346 | BYK Chemie | 0.3 | g |
| 7 | LM | Diacetone alcohol | Kraemer & Martin GmbH | 4.5 | g |
| 8 | LM | 2-Methoxypropanol | Kraemer & Martin GmbH | 4.5 | g |

| | | |
|---|---|---|
| Total | 100.0 | g |

### Example 4

Formulation of an aqueous, physically drying and UV-curing coating composition based on UV-1, Bayhydrol XP2648 (BMS AG) and addition of Bindzil® CC40 (Eka Chemicals AB) containing a polyisocyanate crosslinking agent Bayhydur® 305 (BMS AG)

| Item | | Starting material | Manufacturer | Content | |
|---|---|---|---|---|---|
| 1 | BM | UV-1 | | 54.8 | g |
| 2 | BM | Bayhydrol XP2648 | Bayer MaterialScience AG | 8.9 | g |
| 3 | NP | Bindzil ® CC40 | Eka Chemicals AB | 23.6 | g |
| 4 | A | Irgacure 500 | Ciba AG | 0.7 | g |
| 5 | A | TegoGlide 410 | Evonik Tego Chemie | 0.4 | g |
| | | | GmbH | | |
| 6 | A | BYK 346 | BYK Chemie | 0.3 | g |
| 7 | LM | Diacetone alcohol | Kraemer & Martin GmbH | 4.4 | g |
| 8 | LM | 2-Methoxypropanol | Kraemer & Martin GmbH | 4.4 | g |
| 9 | A | DBTL 1% soln. in DAA* | Sigma Aldrich | 0.9 | g |
| 10 | V | Bayhydur 305 | Bayer MaterialScience AG | 1.6 | g |

| | |
|---|---|
| 100.0 | g |

### Example 5

Classical, solvent-based, dual-cure coating composition as in Example 11 in EP 1790673/DE 102005057245.

### Example 6

Commercially available coated film Autoflex XtraForm™ from MacDermid Autotype Ltd.

### Production of Coated and Pre-Crosslinked Polymer Films:

Examples 1 to 5 were applied using a commercial doctor knife (required wet coat thickness 100 μm) onto one side of PC polymer films (Makrofol® DE1-1, film thickness 250 μm and 375 μm, sheet size DIN A4). After a solvent evaporation phase of 10 min at 20° C. to 25° C., the coated films were dried or pre-cured for 10 min at 110° C. in a circulating air oven. The coated films thus produced, as well as example 6, were then touch-dry at this point in the process chain.

### Production of Printed Polymer Films:

Some of these PC polymer films coated on one side were printed with a physically drying, silver metallic screen printing ink, Noriphan® HTR (Pröll KG, Weiβenburg, DE), according to the manufacturer's instructions by means of a screen-printing process (semi-automatic screen-printing machine, manufactured by ESC (Europa Siebdruck Centrum); fabric 80 THT polyester; RKS squeegee; dry film thickness: 10-12 μm) and dried in a tunnel dryer at 80° C. and at a throughput rate of 2 m/min for 2.5 min.

### Thermoforming:

PC polymer films coated and printed in this way were formed using a mould (heating/ventilation panel for the production of films for car interior fittings) in a thermoforming plant (Adolf ILLIG, Heilbronn). The essential process parameters for the forming are listed below:

| | |
|---|---|
| Mould temperature: | 100° C. for Makrofol ® DE1-1 |
| Film temperature: | 190° C. for Makrofol ® DE1-1 |
| Heating time: | 20 s for Makrofol ® DE1-1 |

### High-Pressure Forming Process:

The forming of the PC polymer films with the mould described (heating/ventilation panel for the production of films for car interior fittings) took place in a similar manner using HPF equipment (HDVF Penzberg, Kunststoffmaschinen (type: SAMK 360)). The essential process parameters for the forming are listed below:

| | |
|---|---|
| Mould temperature: | 100° C. for Makrofol ® DE1-1 |
| Film temperature: | 140° C. for Makrofol ® DE1-1 |
| Heating time: | 16 s for Makrofol ® DE1-1 |
| Pressure: | 100 bar |

### Curing of the Formed Lacquer Films by UV Radiation:

The UV curing of the formed lacquer films was carried out using UV equipment type U300-M-1-TR from IST Strahlentechnik GmbH, Nürtingen, with a mercury lamp type MC200 (output 80 W/cm). The dose required for cure was determined with an eta plus UMD-1 dosimeter from eta plus electronic. At a continuous curing rate of 3 m/min and with 3 passes through the UV equipment described, a total radiation intensity of 3×1.2 J/cm², i.e. of 3.6 J/cm² was used for the cure of the coated films.

### Production of Shaped Articles by Back Injection Moulding of the Coated Films:

The three-dimensional, UV-cured polymer films were back injection moulded using an injection moulding machine, type Allrounder 570C (2000-675) from Arburg, Loβburg, with Bayblend® T65 (amorphous, thermoplastic polymer blend based on polycarbonate and ABS; Bayer MaterialScience AG, Leverkusen, DE). The essential parameters of the back injection moulding are listed below:

| | | |
|---|---|---|
| Injection temperature: | 260° | C. melt |
| Mould temperature: | 60° | C. |
| Injection pressure: | 1400 | bar |
| Mould filling time: | 2 | s |

### Test Methods:

### Abrasion Resistance Using Taber Abrasion Tester and Scattered Light Measurement According to DIN 52347:

A flat test piece measuring 100 mm×100 mm was prepared from the coated film previously cured by actinic radiation. The initial haze value of this test piece was determined in accordance with ASTM D1003 using a Haze Gard Plus from BYK-Gardner. The coated side of the test piece was then scratched with a Taber Abraser model 5131 from Erichsen according to DIN 52347 or ASTM D1044 using the CS10F wheels (type IV; grey colour) and 500 g loading weight per abrasion wheel. By determining the final haze value after 25, 100, 500 and 1000 rotations, Δhaze values of the test piece could be determined from the difference between final haze value at a given number of rotations and initial haze value.

### Scratch Resistance Using Pencil Hardness Tester According to ISO 15184/ASTM D3363:

A flat test piece was prepared from the coated film previously cured by actinic radiation, and affixed to a glass plate. The pencil hardness was determined using the Wolf-Wilbum pencil hardness tester from BYK-Gardner and pencils from Cretacolor. In accordance with ISO 15184, the designation of the hardest pencil which does not cause any surface damage in the test arrangement under a pressure of 750 g at an angle of 45° is given.

### Adhesive Strength by Means of Cross-Hatch Testing According to EN ISO 2409/ASTM D3359:

The adhesive strength of the lacquer layer of the coated lacquered film which had only been pre-dried and the adhesive strength of the coating cured by actinic radiation on the lacquered film were determined. The following were evaluated:
a.) cross-hatching with and without adhesive tape pull-off (adhesive tape used: Scotch™ 610-1PK from 3M), and
b.) cross-hatching after storage in 98° C. hot water after adhesive tape pull-off (adhesive tape used: see above) for a total period of 4 hours, with evaluation taking place every hour.

### Chemical Resistance:

The formed component cured by actinic radiation and back injection moulded with thermoplastic material (e.g. Bayblend T65) (heating/ventilation panel for a car) has critical deformation radii of up to r=0.8 mm. The chemical resistance of these highly deformed and stressed areas with a thin lacquer layer thickness was investigated as follows. Aggressive lotions and creams known to the person skilled in the art (e.g. Atrix hand cream, Daimler Chrysler AG sun oil test mixture DBL7384, Garnier Ambre Solaire for children SF30 and Nivea Sun moisturising sun lotion for children SF30) were applied to the areas described and then stored in a heating chamber for 24 hours at 80° C. Following this loading, residues were carefully removed with water and the samples were dried. A visual evaluation of the surface in the area of exposure took place.

### Blocking Resistance:

To simulate the blocking resistance of rolled, pre-dried lacquered films, standard test methods as described e.g. in DIN 53150 are not sufficient, and so the following test was performed. The lacquer materials were applied using a commercial doctor knife (required wet coat thickness 100 μm) to Makrofol DE 1-1 films (375 μm). Following a solvent evaporation phase of 10 min at 20° C. to 25° C., the lacquered films were dried for 10 min at 110° C. in a circulating air oven. After a cooling phase of 1 min, a commercial adhesive laminating film GH-X173 natural (Bischof und Klein, Lengerich, Germany) was applied crease-free onto the dried lacquered film using a plastic paint roller over an area of 100 mm×100 mm. The laminated film section was then loaded over the entire surface with a 10 kg weight for 1 hour. After this, the laminating film was removed and the lacquer surface was evaluated visually.

### Film Thickness of the Lacquer Layer:

The film thickness of the lacquer layers cured by actinic radiation was determined with a white light interferometer ETA-SST from ETA-Optik GmbH.

### Results:

The results of the tests are shown in the following two tables.

| Example | | 1 | 2 | 3 | 4 | 5 | 6 |
|---|---|---|---|---|---|---|---|
| Film thickness | | 23.0 | 24.0 | 22.0 | 22.0 | 31.0 | 7.5 |
| μm] | | | | | | | |
| Transparency | | 90.2 | 90.1 | 90.1 | 90.1 | 90.1 | 92.6 |
| [%] | | | | | | | |
| Haze [%] | | 0.5 | 0.6 | 0.7 | 0.5 | 0.4 | 1.1 |
| Abrasion | 25 cycles | 3.8 | 2.4 | 3.9 | 4.7 | 10.8 | 2.9 |
| resistance | 100 cycles | 7.7 | 6.8 | 7.3 | 9.3 | 22.2 | 4.4 |
| (Δ-Haze | 500 cycles | 18.0 | 7.3 | 7.5 | 9.6 | 43.4 | 20.5 |
| values) [%] | 1000 cycles | 24.5 | 5.9 | 5.7 | 7.3 | 53.7 | 22.4 |
| Pencil hardness | 750 g load | 2H | 2H | 2H | 2H | H | 2H |
| Adhesion after | GS | 0 | 0 | 0 | 0 | 0 | 0 |
| UV-curing | KBA | 0 | 0 | 0 | 0 | 0 | 0 |
| | KBA | 0 | 0 | 0 | 0 | 5 | 5 |
| | (1 h KT) | | | | | | |
| | KBA | 0 | 0 | 0 | 0 | — | — |
| | (2 h KT) | | | | | | |
| | KBA | 0 | 0 | 0 | 0 | — | — |
| | (4 h KT) | | | | | | |

Key: GS: cross hatch; KBA: adhesive tape pull-off; KT: KBA after n hours storage in 98° C. hot water.
Evaluation of cross hatch: scale of 0 to 5, where 0 is very good adhesion and 5 is almost complete delamination of the lacquer layer.

| | Chemical resistance - storage after 24 h at 80° C. | | | | Blocking resistance |
|---|---|---|---|---|---|
| | | DC AG | | Nivea Sun | Loading with GH- |
| | Atrix | sun oil test | Garnier Ambre | moisturising sun | X173 and 10 kg on |
| | hand | mixture | Solaire for | lotion for | a film area of |
| Example | cream | DBL7384 | children SF30 | children SF30 | 100 mm × 100 mm |
| 1 | OK | OK | OK | Delamination, | Severe markings |
| | | | | severe cracking | |
| 2 | OK | OK | OK | OK | Slight markings |
| 3 | OK | OK | OK | OK | No markings |
| 4 | OK | OK | OK | OK | No markings |
| 5 | OK | OK | Delamination, | Delamination, | Severe markings |
| | | | severe cracking | severe cracking | |
| 6 | OK | Slight | Severe cracking | OK | Supplied by |
| | | cracking | | | manufacturer with |
| | | | | | adequate blocking |
| | | | | | resistance |

### SUMMARY

The test results show that, by using the coating composition (examples 2 to 4) and process according to the invention, surfaces can be achieved with excellent resistances to chemicals at elevated temperatures up to 80° C. on deformed films. Furthermore, excellent abrasion resistances and scratch resistances are achieved, even under prolonged loading, with consistently high transparency of the film. The blocking resistance of the coated, but not UV-cured, film is significantly better than that of the prior art (examples 5+6) and than for a film without inorganic nanoparticles in the coating (example 1), so that the economically important process of film coating from roll to roll with direct lamination of the non-UV-cured lacquered film can be used.

1. A film comprising a radiation-curing coating, wherein said radiation-curing coating comprises a polyurethane polymer comprising (meth)acrylate groups and which is obtained from the reaction of a reaction mixture comprising:
(a) polyisocyanates; and
(b1) compounds which comprise (meth)acrylate groups and are reactive towards isocyanates
and wherein said radiation-curing coating further comprises inorganic nanoparticles having an average particle size in the range of from 1 nm to 200 nm.

2. The film of claim 1, wherein said film is a polycarbonate film with a thickness in the range of from 10 nm to 1500 nm.

3. The film of claim 1, wherein the weight average Mw of said polyurethane polymer is in the range of from 250000 g/mol to 350000 g/mol.

4. The film of claim 1, wherein said reaction mixture further comprises:
(b2) compounds having a hydrophilically modifying action with ionic groups and/or groups capable of conversion to ionic groups and/or nonionic groups;
(b3) polyol compounds having an average molecular weight in the range of from 50 g/mol to 500 g/mol and a hydroxyl functionality of 2 or greater; and
(b4) aminofunctional compounds.

5. The film of claim 4, wherein said reaction mixture further comprises:
(b5) polyol compounds with an average molecular weight in the range of from 500 g/mol to 13000 g/mol and an average hydroxyl functionality in the range of from 1.5 to 5.

6. The film of claim 4, wherein the number of hydroxyl groups in (b3) represents a proportion of the total amount of hydroxyl groups and amino groups in the range of from 5 mole % to 25 mole %, and wherein the hydroxyl groups of water in the reaction mixture are not taken into account.

7. The film of claim 1, wherein said radiation-curing coating further comprises:
(b6) compounds which comprise (meth)acrylate groups and are non-reactive towards isocyanates and/or have not been reacted.

8. The film of claim 1, wherein the surface of said inorganic nanoparticles in said coating is modified by the covalent and/or non-covalent attachment of other compounds.

9. A process for producing the film of claim 1, comprising:
preparing a polymer dispersion, wherein said dispersion comprises a polyurethane polymer which comprises (meth)acrylate groups and which is obtained from the reaction of a reaction mixture comprising:
(a) polyisocyanates; and
(b1) compounds which comprise (meth)acrylate groups and are reactive towards isocyanates;
and wherein said dispersion also comprises inorganic nanoparticles having an average particle size in the range of from 1 nm to 200 nm;
coating a film with said polymer dispersion; and
drying said polymer dispersion.

10. A shaped article comprising the film of claim 1.

11. A process for producing a shaped article comprising a radiation-cured coating comprising:
preparing the film of claim 1;
forming said film into a shaped article; and
curing the radiation-curing coating on said shaped article.

12. The process of claim 11, wherein the forming of the shaped article takes place in a mould under a pressure in the range of from 20 bar to 150 bar.

13. The process of claim 11, wherein the forming of the shaped article takes place at a temperature in the range of from 20° C. to 60° C. below the softening point of the material of said film.

14. The process of claim 11, further comprising applying a polymer onto the side of said film opposite the cured radiation-curing coating.

15. A shaped article produced by the process of claim 11.
